(19) United States
(12) Patent Application Publication
(10) Pub. No.: US 2026/0050103 A1
(43) Pub. Date: Feb. 19, 2026

(54) Metal Detector

(71) Applicant: Minelab Electronics Pty. Limited, Mawson Lakes (AU)

(72) Inventor: Philip Shane Wahrlich, Mawson Lakes (AU)

(21) Appl. No.: 19/302,215

(22) Filed: Aug. 18, 2025

(30) Foreign Application Priority Data
Aug. 19, 2024 (AU) 2024902579

(51) Int. Cl. G01V 3/38; G01V 3/10

(52) U.S. Cl. CPC G01V 3/38; G01V 3/105

(57) ABSTRACT

Provided is a method to detect at least one target using a handheld metal detector including transmitting a transmit magnetic field using a transmitter; receiving a receive magnetic field using a receiver to produce one or more receive signals; processing the one or more receive signals to produce a plurality of different processed signals; forming a representation of a vector subspace based on the plurality of different processed signals; processing the representation of the vector subspace with each of a plurality of target models individually to determine a closeness from each of the plurality of target models to the vector subspace; and producing an indicator output indicative of the presence of at least one target based on the closeness from each of the plurality of target models to the vector subspace.

### CROSS-REFERENCE TO RELATED APPLICATION

This application claims priority to Australian Patent Application No. 2024902579 filed Aug. 19, 2024, the disclosure of which is hereby incorporated by reference in its entirety.

### BACKGROUND

### Field

The present disclosure relates to a metal detector.

### Description of Related Art

The general forms of most metal detectors that interrogate soil are either handheld battery-operated units, conveyor-mounted units, or vehicle-mounted units. Examples of handheld products include detectors used to locate gold: explosive land mines or ordnance; or coins and treasure. Examples of conveyor-mounted units include tramp metal detectors used in ore mining operations, and examples of a vehicle-mounted unit include a unit to locate buried land mines.

These metal detectors usually, but not necessarily, consist of transmit electronics generating a repeating transmit signal cycle of a fundamental period, which is applied to an inductor, for example a transmit coil, which transmits a resulting varying magnetic field, sometimes referred to as a transmit magnetic field.

These metal detectors may also contain receive electronics that process a receive signal from a measured receive magnetic field, during one or more receive periods during the repeating transmit signal cycle, to produce an indicator output signal, the indicator output signal at least indicating the presence of at least a metal target within the influence of the transmit magnetic field.

During the processing of the receive signal, the receive signal may be sampled or demodulated, to produce one or more target channels, the one or more target channels may be further processed to produce the indicator output signal.

Objects of interest that are sought by treasure-hunters are often located in geographic regions that have seen historical human habitation or activities. As such, a wide assortment of metallic junk or clutter objects is also commonly found at these locations.

In a military or humanitarian demining context, threat objects such as land mines and improvised explosive devices are often located in areas that also contain a wide assortment of metallic junk or clutter objects, which may be associated with, for example, conflict or human habitation.

Metal detectors commonly measure the complex spectral response of an object. The complex spectral response of an object can be measured at a single frequency, where it is specified by a magnitude and phase. It is also common to measure the complex spectral response of an object at multiple frequencies or at multiple frequency bands. It is not essential that the measurement of the complex spectral response be described in terms of magnitude and phase at different frequencies. Alternatively, the measurement may consist of multiple different channel responses where the different channels are sensitive to different properties of the complex spectral response of the object. For example, different channels sensitive to different frequencies can be used and the spectral response from the object can be expressed in the channel domain rather than in the frequency domain. Based on the measurement of the complex spectral response, metal detectors can generate an indicator output indicative of the identity of the object.

Targets may produce a variety of spectral responses that depend on the shape, composition, and orientation of the target. However, many targets of interest tend to have a dominant characteristic spectral response which may be used to reliably identify them.

When multiple objects are located close together, the metal detector may excite many nearby objects simultaneously and the received spectral response is then a combination of the spectral responses from each excited object. When this is the case, often the received spectral response tends to look most similar to that of the object contributing the largest proportion of the response. For an example, if a deeply-buried non-ferrous coin contributes a small magnitude response and a shallow-buried iron nail contributes a large magnitude response, then the overall response is likely to look most similar to the contribution from the iron nail rather than the contribution from the non-ferrous coin.

It is not uncommon for the presence of metallic junk objects to mask the signature response of objects of interest in the sense that a metal detector would not be able to identify the object of interest sufficiently accurately to warrant a retrieval attempt. It may be the case that the measured spectral response is dominated by the response of a colocated metallic junk object and hence the metal detector may instead identify the presence of the colocated metallic junk object at the location of the object of interest.

The ability to detect non-ferrous objects of interest in the presence of colocated ferrous junk objects is of high value to treasure-hunters and other metal detector operators. Metal detectors with increased capability to detect non-ferrous objects of interest under these circumstances have an advantage over other metal detectors.

The present disclosure offers an alternative over existing prior art.

### SUMMARY

According to a first aspect of the present disclosure, there is provided a method to detect at least one target using a handheld metal detector, comprising: transmitting a transmit magnetic field using a transmitter; receiving a receive magnetic field using a receiver to produce one or more receive signals: processing the one or more receive signals to produce a plurality of different processed signals: forming a representation of a vector subspace based on the plurality of different processed signals: processing the representation of the vector subspace with each of a plurality of target models individually to determine a closeness from each of the plurality of target models to the vector subspace: producing an indicator output indicative of the presence of at least one target based on the closeness from each of the plurality of target models to the vector subspace.

In one form, the step of processing the representation of the vector subspace with each of the plurality of target models individually to determine the closeness from each of the plurality of target models to the vector subspace comprises: calculating a distance between each of the plurality of target models individually and a vector in the vector subspace.

In one form, the vector in the vector subspace from which the distance is calculated is the vector which is closest to each of the plurality of target models individually.

In one form, the closeness from each of the plurality of target models to the vector subspace is determined through a determination of an orthogonality of each of the plurality of target models against the vector subspace.

In one form, the closeness from each of the plurality of target models to the vector subspace is determined through a determination of a distance of each of the plurality of target models from the vector subspace.

In one form, the closeness from each of the plurality of target models to the vector subspace is determined through a comparison of a linear combination of a basis of the vector subspace and each of the plurality of target models.

In one form, the step of processing the representation of the vector subspace comprises processing a complement space of the representation of the vector subspace.

In one form, the vector subspace comprises at least two dimensions.

In one form, the plurality of different processed signals is based on the receive signal received at different times.

In one form, the plurality of different processed signals is based on the receive signal processed by different filters, the different filters having different impulse responses.

In one form, the plurality of different processed signals is based on the receive signal received at different locations.

In one form, the receiver comprises at least two receiver windings, wherein each of the at least two receiver windings produces one of the one or more receive signals.

In one form, the transmitter comprises at least two transmit windings, wherein each of the at least two transmit windings transmits a different transmit magnetic field.

In one form, forming the vector subspace based on the plurality of the different processed signals comprises: forming the vector subspace using linear combinations of the plurality of the different processed signals.

In one form, the vector subspace is a spectral representation of a space spanned by a transformation of the receive signal.

In one form, the target models are a spectral representation of a transformation of an expected response from targets.

In one form, the plurality of target models comprises at least two target models representing a response from soil.

In one form, the transmit magnetic field is a multiple-frequency magnetic field; and wherein the vector subspace comprises a number of dimensions equal to two times a number of frequencies of the multiple-frequency magnetic field.

In one form, the indicator output is a numeric target identification number further indicative of the identity of the at least one target.

In one form, the indicator output is at least two numeric target identification numbers further indicative of identities of at least two targets, and which are displayed in two different regions of a user interface.

In one form, the indicator output is an audio output further indicative of the identity of the at least one target.

In one form, the indicator output is an audio output further indicative of identities of at least two targets.

In one form, the step of producing an indicator output depends on the closeness from each of the target models representing the response from the soil individually to the vector subspace.

According to a second aspect of the present disclosure, there is provided a metal detector configured to perform the method of the first aspect.

According to a third aspect of the present disclosure, there is provided a non-transitory computer readable medium, comprising instructions to perform the method of the first aspect.

### BRIEF DESCRIPTION OF THE DRAWINGS

Embodiments of the present disclosure will be discussed with reference to the accompanying drawings wherein:

FIG. 1 depicts a general form of the present disclosure:

FIG. 2 depicts exemplary components as a function of characteristic frequency for three transmit frequencies according to one embodiment:

FIG. 3 depicts a model explaining a scenario that a conventional metal detector is unlikely to detect accurately; and

FIG. 4 shows the values of ρᵢ for a set of spectral candidate vectors corresponding to the conducting loop of a range of characteristic frequencies.

### DETAILED DESCRIPTION

In the prior art, there are known methods to increase the capability of a metal detector to detect non-ferrous objects colocated with ferrous junk objects. These methods generally attempt to temporally separate the responses from colocated objects in the metal detector response so that each separate response may be identified individually without contaminating each other.

One such approach is to utilise a search coil with a smaller footprint of sensitivity so that the coil predominantly energises a first target without substantially and simultaneously energising a second nearby target. Typically, this may be achieved by utilising a search coil with a smaller size. However, the method has the negative consequence of reducing the detectable depth of deep-buried targets, as well as reducing the area of ground that can be effectively searched with each swing of the search coil.

Another approach is to apply only a small amount of low-pass filtering to the metal detector response (i.e. reducing the amount of low-pass filtering). Low-pass filtering may blur a first target response over a second nearby target response, making a second nearby target less accurately identifiable. Low-pass filtering is commonly used to reduce noise, especially noise due to the electrical grid. Generally, low-pass filtering increases the signal to noise ratio of the metal detector, which increases the maximum depth of detection of the metal detector. Reducing the amount of low-pass filtering to the metal detector response therefore has the negative consequence of reducing the potential detection depth of the metal detector.

Another approach is to effectively widen the region of feature-space used to classify the object of interest. That is, accepting that even if the response does not look exactly like the expected response from the object of interest, it looks sufficiently similar within some tolerance region to the expected response, that the metal detector indicates that an object of interest has been detected. If the tolerance region is widened, the true positive rate will increase. However, a negative consequence of this is that the false positive rate should also be expected to increase as other objects are increasingly misclassified as the object of interest.

Alternative approaches attempt to model the metal detector response as a linear combination of a set of candidate responses. For example, U.S. Pat. No. 9,239,400B2 describes modelling the metal detector response as a linear combination of at least two candidate responses, which may be ferrous or non-ferrous target responses parameterised by a characteristic frequency, or soil responses. The space of combinations of candidate responses is then searched to find the combination of candidate responses which best explains the metal detector response, for example by minimising the sum of squared errors between the measurement and the best-fit linear combination of the candidate responses.

The approach of modelling the metal detector response as a linear combination of a set of candidate responses suffers from several major problems.

Firstly, this approach relies on searching over a set of combinations of candidate responses. There is a rapid growth in the size of the search space due to the combinatorial nature of the search over combinations of candidate responses. It is common for modern metal detectors to classify targets into approximately 100 different classes. If a combination of k objects is selected from a set of n possible objects there are

$${C}_{k}^{n} = \frac{n !}{k ! ( n - k ) !}$$

possible combinations.

For example, if one selects k=2 objects from a set of n=100 possible objects there are

$${C}_{k = 2}^{n = 100} = 4950$$

possible combinations. If one selects k=3 objects from a set of n=100 possible objects there are

$${C}_{k = 3}^{n = 100} = 16 \; 1700$$

possible combinations. The computational complexity of the search over possible combinations quickly becomes costly for practical implementation.

Secondly, while many targets of interest can be accurately modelled as non-permeable, conductive disks of various radii and thicknesses, there is a comparatively very large number of candidate responses required to accurately model the vast diversity of junk objects. Junk objects are often ferrous and varied in shape and size, including irregular shapes. It is commonly known that many junk objects, such as bottle caps and other ferrous objects, have spectral responses which depend on their orientation with respect to the metal detector coil. The size of the set of junk objects further increases the computational burden of the approach of searching over a set of combinations of candidate responses.

The present disclosure increases the capability of a metal detector to detect the presence of objects of interest in the presence of colocated unwanted junk objects. In particular, the present disclosure may improve the capability of a metal detector to detect the presence of targets of interest that are near to other metallic objects or are otherwise obscured by the responses from other objects that constitute noise or clutter.

It was discovered that the presence of these otherwise obscured targets of interest may be effectively detected by utilising information from multiple different measurements of the spectral response at multiple different frequencies.

The multiple different measurements of the spectral response can be made in many different ways, including measurements at different search coil locations relative to the target location, measurements made by utilising multiple different receivers at different locations relative to the target location, and measurements made by utilising multiple different transmitters at different locations relative to the target location, or a combination of these measurement configurations. It is important that the measurement configuration or configurations is such that the different measurements contain contributions from the target of interest and contributions from nearby unwanted junk objects that differ in their relative amplitudes across the different measurements.

The multiple different measurements all tend to lie in a low-dimensional spectral subspace. The dimension of this subspace is approximately equal to the number of linearly independent spectral responses that contribute to the measurements. At least measurement the response is a linear combination of the contributing spectral responses. For example, if there are two objects, each contributing a single n-dimensional spectral response to the measurements, the measurements all tend to lie in a two-dimensional subspace which is a subset of the larger n-dimensional spectral vector space. However, we note that this is only approximately true due to the presence of noise.

The presence of a target of interest may be detected by testing whether the expected spectral response from this target of interest lies close to the low-dimensional spectral subspace. The approach of the present disclosure contrasts with the typical approach of determining which of a set of candidate spectral responses most resembles a particular measurement.

The fundamental difference between these two approaches is that the present disclosure effectively tests whether the candidate response can be accurately approximated as a linear combination of the multiple measurements, whereas prior approaches test whether a measurement can be accurately approximated as a single candidate response or sometimes a linear combination of multiple different candidate responses.

More concretely, it is typical to model the spectral measurement vector x as

$$x = {\sum }_{i = 1}^{K} {a}_{i} {s}_{i} + e$$

where K is the number of unique spectral responses contributing to the measurement, the ith spectral response sᵢ having an amplitude aᵢ. The measurement also contains some noise e.

It is known that the identity of an object may be estimated by comparing the spectral measurement vector x to a dictionary of candidate spectral responses, and testing which of the candidate spectral responses most closely resembles the measurement, considering also that the candidate vector may require some scaling factor to be applied for it to resemble the measurement. This may be achieved, for example, by selecting the best-fit candidate spectral response in the least-squares sense.

Such an approach is effective when there is only a single target present, contributing only a single dominant spectral response to the measurement. However, this approach is problematic when there are many targets present, especially when the dominant spectral response in a mixture of responses is due to another object which is not the target of interest. In such a case as described, the prior approach will tend to misidentify the target as being the other object that has contributed the dominant spectral response to the mixture of responses.

To improve upon this situation the present disclosure considers a set of measurements of the mixture of objects. Each measurement is a spectral response measurement vector x. The set of m measurements may be represented by a measurement matrix X, with each x being a column of X so that

$$X = S A + E$$

where the columns of S are the unique n-dimensional spectral responses contributing to the measurements, and each row of A contains the amount that each spectral response contributes to a corresponding measurement. E is a n×m noise matrix.

In the present disclosure, the aim is to test whether it is possible that a particular candidate spectral response sⱼ is a column of S, or more generally, whether it lies within the space spanned by the columns, the column-space, of S.

In the absence of noise, if sⱼ is in the column-space of X then it is also in the column-space of S. However, due to the presence of noise E, X is typically full-rank and thus, in this case, all possible sⱼ are in the column-space of X. To mitigate the effect of noise on the estimation of the column-space of X, one can instead use a low-rank approximation of X. This may be achieved, for example, by taking the singular value decomposition of X, setting the smallest singular values to zero.

The present invention involves evaluating the closeness of a particular candidate spectral response sⱼ to the vector subspace spanned by the measurement matrix X or a low-rank approximation of X. When a candidate spectral response sⱼ lies sufficiently close to this vector subspace, the corresponding target represented by the candidate spectral response sⱼ can be declared as being present. It is therefore possible to detect particular targets of interest in proximity to other clutter objects with temporally overlapping responses.

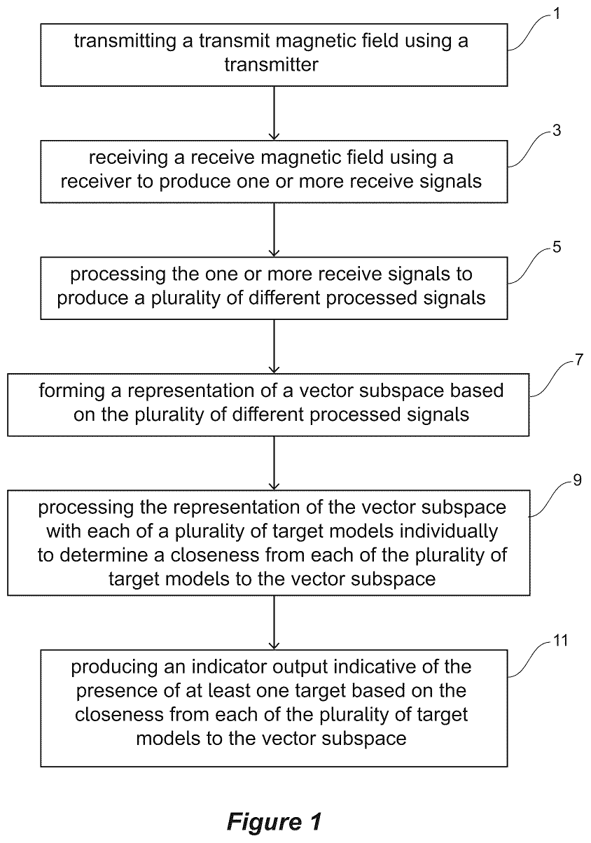

FIG. 1 depicts a general form of the present disclosure. In this general form, there is provided a method to detect a target using a handheld metal detector. The first step comprises transmitting a transmit magnetic field using a transmitter 1. The next step comprises receiving a receive magnetic field using a receiver to produce one or more receive signals 3. These two steps may take many forms known to a person skilled in the art, as long as the transmitter transmits a magnetic field to excite a target and the receiver receives signals indicative of the presence of the target within the influence of the transmitted magnetic field. The transmitter and receiver may take many different forms depending on the designs and the implementations of the metal detector.

The next step comprises processing the one or more receive signals to produce a plurality of different processed signals 5. There are different ways to obtain different processed signals. In one form, different processed signals are based on one or more receive signals received at different times. In another form, the plurality of different processed signals is based on the receive signal received at different locations. For example, the receiver may comprise at least two receiver windings, wherein each of the at least two receiver windings produce one of the one or more receive signals. In one form, the plurality of different processed signals is based on the receive signal processed by different filters, each of the different filters having different impulse responses.

The next step comprises forming a representation of a vector subspace based on the plurality of different processed signals 7. In one form, the vector subspace comprises at least two dimensions. In one form, the vector subspace is a spectral representation of the space spanned by a transformation of the receive signal. In one form, the transmit magnetic field is a multiple-frequency magnetic field, and that the vector subspace comprises a number of dimensions equal to two times a number of frequencies of the multiple-frequency magnetic field. In one form, forming the vector subspace based on the plurality of the different processed signals comprises forming the vector subspace using linear combinations of the plurality of the different processed signals.

The next step comprises processing the representation of the vector subspace with each of a plurality of target models individually to determine a closeness from each of the plurality of target models to the vector subspace 9. This can be done, as an example, by calculating the distance between each of the plurality of target models individually and a vector in the vector subspace. The vector in the vector subspace from which the distance is calculated is the vector which is closest to each of the plurality of target models individually. The closeness from each of the plurality of target models to the vector subspace may be determined through a determination of a degree of orthogonality of each of the plurality of target models against the vector subspace. Alternatively, the closeness from each of the plurality of target models to the vector subspace is determined through a determination of a distance of each of the plurality of target models from the vector subspace. Alternatively, the closeness from each of the plurality of target models to the vector subspace is determined through a comparison of a linear combination of a basis of the vector subspace and each of the plurality of target models.

In a form, the step of processing the representation of the vector subspace comprises processing a complement space of the vector subspace.

In one form, the target models are a spectral representation of a transformation of the expected response from targets. In one form, target models comprise at least two models representing the response from soil.

The next step comprises producing an indicator output indicative of the target based on the closeness from each of the plurality of target models to the vector subspace 11. The step of producing an indicator output may depend on the closeness from each of the target models representing the response from the soil individually to the vector subspace.

The signal processing portion of above method and its various forms may be implemented entirely in software. Software, comprising various instructions, may be stored in a non-transitory computer readable medium in a metal detector. The signal processing is explained in greater detail below.

In a first embodiment, there is provided a three-frequency metal detector. The receive signal is demodulated to produce in-phase and quadrature components for each of the three frequencies to produce a measurement vector at time t

$${x}_{t} = [ \begin{matrix}{I}_{0 , t} \\ {Q}_{0 , t} \\ {I}_{1 , t} \\ {Q}_{1 , t} \\ {I}_{2 , t} \\ {Q}_{2 , t}\end{matrix} ]$$

where I_{k,t} and Q_{k,t} are the in-phase component and quadrature component respectively for the kth frequency for the measurement at time t.

Multiple measurements are gathered at m≥n different times to form a measurement matrix X as

$$X = [ {x}_{0} {x}_{1} , … , {x}_{m} ]$$

It is assumed that there are at most C<n different objects contributing responses to the measurements X. To denoise the measurements, a low-rank approximation of X is generated. Suppose that

$$X = U \sum {V}^{T}$$

is the singular value decomposition of X, where U and V are orthogonal matrices, and Σ=diag(σ₁, . . . , σₙ) is the n×m rectangular diagonal matrix with singular values σ₁≥ . . . ≥σₙ. A rank-C approximation X_{C} is constructed as

$${X}_{C} = {\sum }_{i = 1}^{C} {σ}_{i} {u}_{i} {v}_{i}^{T}$$

where u¿ and v¿ are the ith columns of U and V respectively. It may also be written as

$${X}_{C} = U {\sum }_{C} {V}^{T}$$

where Σ_{c}=diag(σ₁ , . . . , σ_{C}, 0, . . . ,0) is the n×m rectangular diagonal matrix with singular values σ₁≥ . . . ≥σ_{C} occupying the first C elements on the diagonal, and all other elements on the diagonal are zero. With X_{C} being a low-rank approximation of X, the columns of X_{C} span a vector subspace that is a subset of the larger spectral vector space.

It will become useful later to consider the Moore-Penrose pseudo-inverse of X_{C}, which may be expressed in terms of the singular value decomposition as

$${X}_{C}^{+} = V {\sum }_{C}^{+} {U}^{T}$$

where Σ_{C}⁺ is the pseudo-inverse of Σ_{C}, which may be obtained by transposing the matrix and replacing the non-zero diagonal values with their multiplicative inverses.

Furthermore, it is useful to consider the following product

$$\begin{matrix}{X}_{C} {X}_{C}^{+} = ( U {\sum }_{C} {V}^{T} ) ( V {\sum }_{C}^{+} {U}^{T} ) \\ = U {\sum }_{C} {\sum }_{C}^{+} {U}^{T} \\ = U {D}_{C} {U}^{T}\end{matrix}$$

where D_{C}=diag(1, . . . , 1, 0, . . . ,0) is the n×n diagonal matrix with 1 as the first C elements on the diagonal and the remaining elements being 0.

Then it is tested whether it is possible that a particular spectral candidate vector sᵢ could be contributing to the measurements X. It may be expected that if sᵢ contributes to X then there should be some linear combination b of X_{C} such that

$${X}_{C} b = {s}_{i}$$

In other words, it may be expected that sᵢ is in the vector subspace spanned by the columns of X_{C}. We can estimate the degree to which this is true by evaluating how close X_{C}\hat{b} is to sᵢ, where \hat{b} is a best-fit estimate that minimises the Euclidian distance between X_{C}\hat{b} and sᵢ. Geometrically, we can interpret this as evaluating the closeness, as measured by the Euclidian distance, between sᵢ and the vector subspace spanned by X_{C}. There are many other ways that could be used to evaluate the closeness of sᵢ and the vector subspace spanned by X_{C}. Other distance metrics could be used, for example other Lₚ metrics such as the L₁ metric and L_{∞} metric, also known as the Manhattan distance and Chebyshev distance respectively. Alternatively, an angular distance metric could be used, for example the cosine similarity.

A best-fit estimate \hat{b} can be calculated as

$$\hat{b} = {X}_{C}^{+} {s}_{i}$$

where the symbol + denotes the Moore-Penrose pseudo-inverse.

Then a residual vector rᵢ is calculated as

$$\begin{matrix}{r}_{i} = {X}_{C} \hat{b} - {s}_{i} \\ = {X}_{C} {X}_{C}^{+} {s}_{i} - {s}_{i} \\ = ( U {D}_{C} {U}^{T} - I ) {s}_{i}\end{matrix}$$

where we have used that X_{C}X_{C}⁺=UD_{C}U_{T} as mentioned earlier.

The sum of squared residuals rᵢ^{T}rᵢ is a measure of how accurately sᵢ may be modelled as a linear combination of the columns of X_{C}. The sum of squared residuals rᵢ^{T}rᵢ may be expressed as

$$\begin{matrix}{r}_{i}^{T} {r}_{i} = {{s}_{i}^{T} ( {UD}_{C} {U}^{T} - I )}^{T} ( U {D}_{C} {U}^{T} - I ) {s}_{i} \\ = {s}_{i}^{T} ( {UD}_{C} {U}^{T} U {D}_{C} {U}^{T} - 2 U {D}_{C} {U}^{T} + I ) {s}_{i} \\ = {s}_{i}^{T} ( I - U {D}_{C} {U}^{T} ) {s}_{i}\end{matrix}$$

It is expected that, in the absence of noise, if sᵢ is one of no more than C unique spectral responses contributing to X, then rᵢ^{T}rᵢ=0. Otherwise, rᵢ^{T}rᵢ≠0.

We may therefore test a set candidate of spectral responses and declare that a particular spectral response contributes to the measurements based on rᵢ^{T}rᵢ, for example if rᵢ^{T}rᵢ<γ for some threshold value γ. In this way, if two candidate spectral responses both contribute to the measurements, both should have corresponding squared residuals with rᵢ^{T}rᵢ<γ. We can therefore use rᵢ^{T}rᵢ<γ or a similar construction to detect the presence of particular spectral responses in a mixture of different spectral responses.

In a second embodiment, the spectral candidate responses sᵢ are normalised, so that one might have

$$\begin{matrix}{r}_{i}^{T} {r}_{i} = \frac{{s}_{i}^{T} ( I - U {D}_{C} {U}^{T} ) {s}_{i}}{{s}_{i}^{T} {s}_{i}} \\ = 1 - \frac{{s}_{i}^{T} {UD}_{C} {U}^{T} {s}_{i}}{{s}_{i}^{T} {s}_{i}}\end{matrix}$$

where D_{C}=diag(1, . . . , 1, 0, . . . ,0) is the n×n diagonal matrix with 1 as the first C elements on the diagonal and the remaining elements being 0.

In a third embodiment, a surrogate objective function ρ is constructed as

$$\begin{matrix}{ρ}_{i} = \frac{1}{{r}_{i}^{T} {r}_{i}} \\ = {( 1 - \frac{{s}_{i}^{T} {UD}_{C} {U}^{T} {s}_{i}}{{s}_{i}^{T} {s}_{i}} )}^{- 1}\end{matrix}$$

and note that the sᵢ that minimises rᵢ^{T}rᵢ also maximises ρᵢ. Thus, one may assess which candidates sᵢ of a set of candidates are most likely present by selecting the candidates which give the largest value of ρᵢ.

Consider the case where one defines the spectral candidate vectors representing the well-known in-phase and quadrature responses, I and Q, from a conducting loop of characteristic frequency fᵢ measured at three frequencies, f_{Tx0}, f_{Tx1}, and f_{Tx2}, as

$${s}_{{f}_{i}} = [ \begin{matrix}{s}_{I , {f}_{Tx 0} , {f}_{i}} \\ {s}_{Q , {f}_{Tx 0} , {f}_{i}} \\ {s}_{I , {f}_{Tx 1} , {f}_{i}} \\ {s}_{Q , {f}_{Tx 1} , {f}_{i}} \\ {s}_{I , {f}_{Tx 2} , {f}_{i}} \\ {s}_{Q , {f}_{Tx 2} , {f}_{i}}\end{matrix} ]$$

$$where$$

$${s}_{I , {f}_{T x} , {f}_{i}} = \frac{{( {f}_{T x} / {f}_{i} )}^{2}}{1 + {( {f}_{T x} / {f}_{i} )}^{2}}$$

$${s}_{Q , {f}_{Tx} , {f}_{i}} = \frac{( {f}_{T x} / {f}_{i} )}{1 + {( {f}_{T x} / {f}_{i} )}^{2}}$$

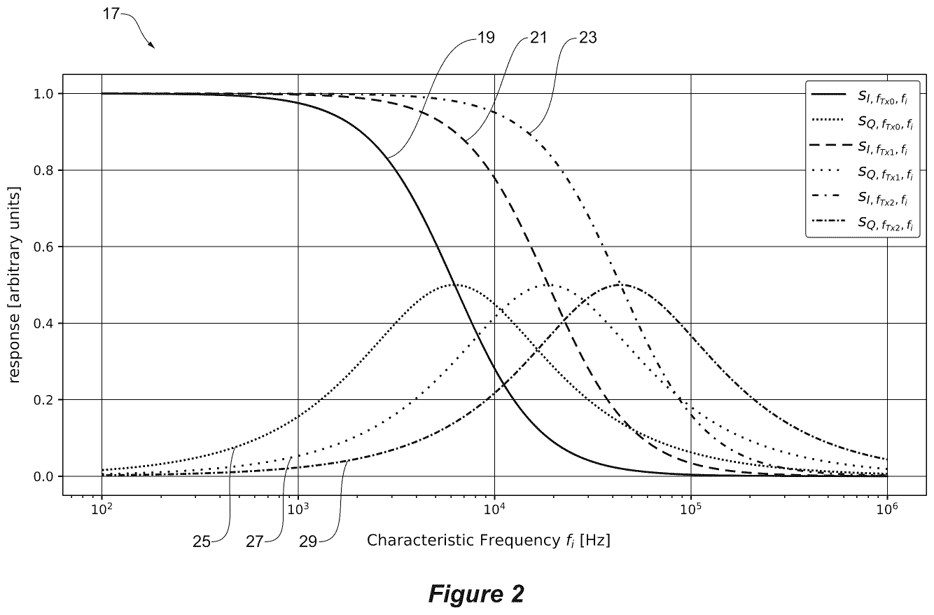

As an example, FIG. 2 depicts exemplary components as a function of characteristic frequency for three transmit frequencies according to one embodiment. In this example, FIG. 2 shows the components of s_{f}_{ᵢ} as a function of characteristic frequency fᵢ given f_{Tx0}=6250 Hz, f_{Tx1}=18750 Hz, and f_{Tx2}=43750 Hz. In particular, traces 19 and 25 represent in-phase and quadrature responses respectively for f_{Tx0}=6250 Hz: traces 21 and 27 represent in-phase and quadrature responses for f_{Tx1}=18750 Hz; traces 23 and 29 represent in-phase and quadrature responses for f_{Tx2}=43750 Hz.

Furthermore, consider a measurement matrix X defined such that the columns of X are linear combinations of two spectral candidate vectors, S_{10 kHz} and S_{100 kHz}, as

$$X = {s}_{10 k H z} {a}_{10 k H z}^{T} + {s}_{100 k H z} {a}_{100 k H z}^{T}$$

where the row vectors

$${a}_{100 H z}^{T} and {a}_{100 k H z}^{T}$$

describe the amplitudes of the spectral candidate vectors for each measurement.

In this example,

$${a}_{100 k H z}^{T}$$

(trace 31) is intentionally set to have values much larger than

$${a}_{10 k H z}^{T}$$

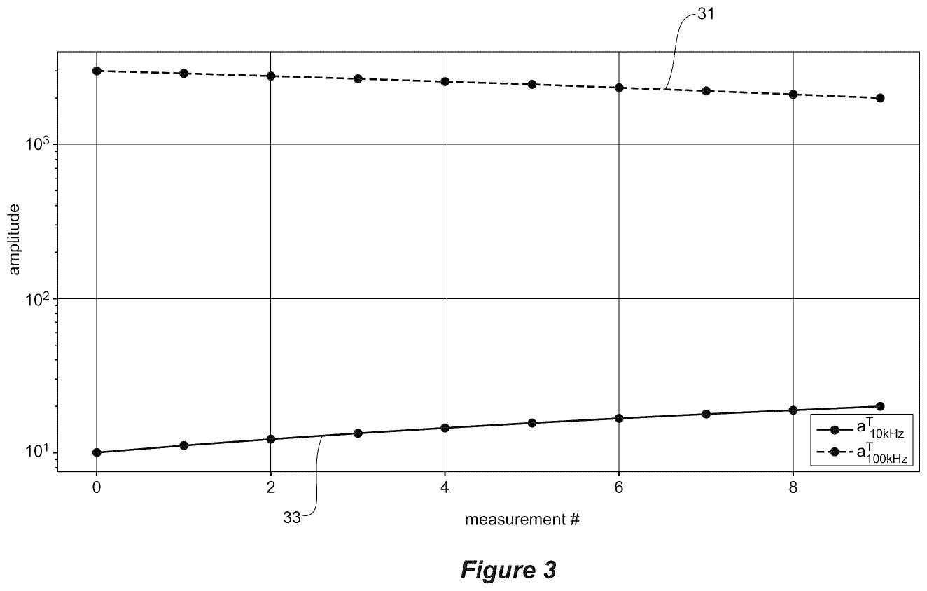

(trace 33), as shown in FIG. 3. This scenario models a situation where a coin response represented by the s_{10 kHz} component is small compared to the response from a piece of aluminium foil junk represented by the s_{100 kHz} component. In such a scenario a conventional metal detector is unlikely to accurately identify the coin, as the overall response in all measurements is dominated by the response from the aluminium foil junk.

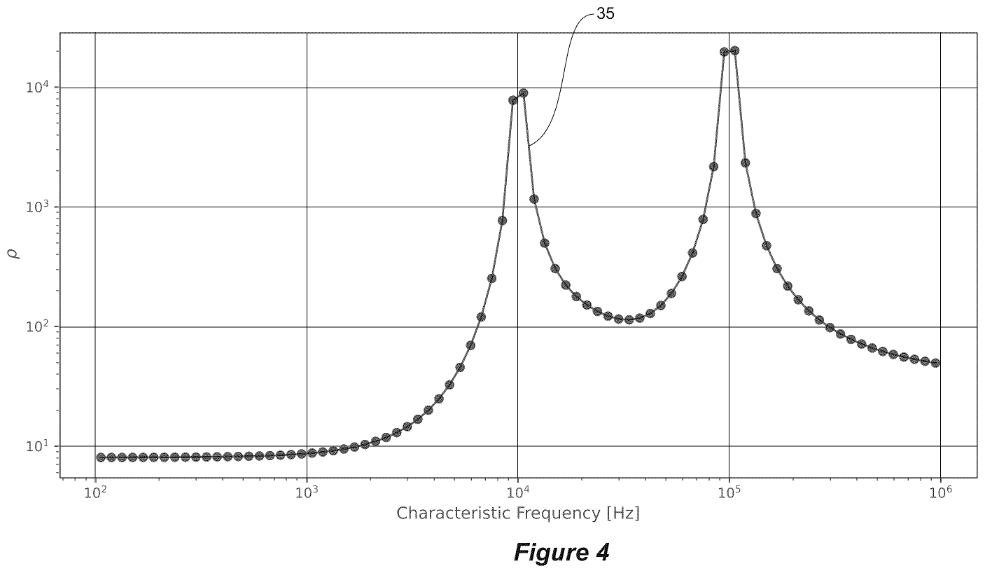

FIG. 4 shows using trace 35 the values of ρᵢ for a set of spectral candidate vectors corresponding to the conducting loop of a range of characteristic frequencies, as described earlier, given a rank −4 approximation of the measurement matrix X. It may clearly be seen that this pseudo-spectrum has two prominent peaks at approximately 10 kHz and 100 kHz, corresponding to the two spectral vectors that contributed to the measurement matrix. Thus, the presence of the 10 kHz target is detectable, even when there is also a much larger, interfering response from a junk item.

In a fourth embodiment, the target of interest to be identified is the soil in the presence of a metallic junk object. That is, we wish to estimate the spectral response from the soil when the measurements consist of mixtures of the soil spectral response and the spectral response of a metallic junk object.

Metal detectors typically employ a calibration technique commonly referred to as “ground balance” wherein the metal detector signal processing is adjusted so as not to respond to the soil. There are many ways in which this may be accomplished. Typically, a spectral response from the soil is assumed or measured and subsequently, the component of the metal detector response in the direction of the spectral response vector is suppressed so that the metal detector is insensitive to the response from the soil.

It is challenging to measure the spectral response in environments where the soil is contaminated by metallic junk objects. Typically, the operator must locate an area of soil that is free of metallic contamination to perform the “ground balance” procedure in which a measurement of the spectral response is made. In many situations this is undesirable. For example, when the environment is highly cluttered with metallic objects and finding an area free of such clutter is difficult and time consuming. It is also possible that the measurement of the soil response is contaminated by the response from nearby metallic junk objects, reducing the effectiveness of the “ground balance” procedure. The present disclosure may be used to estimate the soil spectral response in the presence of metallic clutter objects. In this case, the pi metric defined earlier is calculated for a set of spectral responses sᵢ corresponding to candidate soil spectral responses. The soil spectral response may be estimated to be the particular candidate soil spectral response that maximises ρᵢ.

In this specification the terms “ground” and “soil” are used interchangeably. As understood by a person skilled in the art, the terms “ground” and “soil” mean surfaces of earth where targets may be contained within. The surfaces are often solid, may be homogenous or may be a combination of various soil types, and may contain moisture or water.

Those of skill in the art would understand that information and signals may be represented using any of a variety of technologies and techniques. For example, data, instructions, commands, information, signals, bits, symbols, and chips referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. For a hardware implementation, processing may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number of source code or object code segments or instructions, and may reside in any computer readable medium such as a RAM memory, flash memory, ROM memory, EPROM memory, registers, a hard disk, a removable disk, a CD-ROM, a DVD-ROM or any other form of computer readable medium. In the alternative, the computer readable medium may be integral to the processor. The processor and the computer readable medium may reside in an ASIC or related device. The software codes may be stored in a memory unit and executed by a processor. The memory unit may be implemented within the processor or external to the processor, in which case it may be communicatively coupled to the processor via various means as is known in the art.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the disclosure is not restricted in its use to the particular application described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope of the disclosure as set forth and defined by the following claims.

Please note that the following claims are provisional claims only, and are provided as examples of possible claims and are not intended to limit the scope of what may be claimed in any future patent applications based on the present application. Integers may be added to or omitted from the example claims at a later date so as to further define or re-define the scope.

1. A method to detect at least one target using a handheld metal detector, comprising:
transmitting a transmit magnetic field using a transmitter;
receiving a receive magnetic field using a receiver to produce one or more receive signals:
processing the one or more receive signals to produce a plurality of different processed signals:
forming a representation of a vector subspace based on the plurality of different processed signals:
processing the representation of the vector subspace with each of a plurality of target models individually to determine a closeness from each of the plurality of target models to the vector subspace: and
producing an indicator output indicative of the presence of at least one target based on the closeness from each of the plurality of target models to the vector subspace.

2. The method according to claim 1, wherein the step of processing the representation of the vector subspace with each of the plurality of target models individually to determine the closeness from each of the plurality of target models to the vector subspace comprises:
calculating a distance between each of the plurality of target models individually and a vector in the vector subspace.

3. The method according to claim 1, wherein the closeness from each of the plurality of target models to the vector subspace is determined through a determination of an orthogonality of each of the plurality of target models against the vector subspace.

4. The method according to claim 1, wherein the closeness from each of the plurality of target models to the vector subspace is determined through a determination of a distance of each of the plurality of target models from the vector subspace.

5. The method according to claim 1, wherein the closeness from each of the plurality of target models to the vector subspace is determined through a comparison of a linear combination of a basis of the vector subspace and each of the plurality of target models.

6. The method according to claim 1, wherein the step of processing the representation of the vector subspace comprises processing a complement space of the representation of the vector subspace.

7. The method according to claim 1, wherein the plurality of different processed signals is based on the receive signal received at different times.

8. The method according to claim 1, wherein the plurality of different processed signals is based on the receive signal received at different locations.

9. The method according to claim 1, wherein the receiver comprises at least two receiver windings, wherein each of the at least two receiver windings produces one of the one or more receive signals.

10. The method according to claim 1, wherein the transmitter comprises at least two transmit windings, wherein each of the at least two transmit windings transmits a different transmit magnetic field.

11. The method according to claim 1, wherein the step of forming the vector subspace based on the plurality of the different processed signals comprises:
forming the vector subspace using linear combinations of the plurality of the different processed signals.

12. The method according to claim 1, wherein the vector subspace is a spectral representation of a space spanned by a transformation of the receive signal.

13. The method according to claim 1, wherein the target models are a spectral representation of a transformation of an expected response from targets.

14. The method according to claim 1, wherein the plurality of target models comprises at least two target models representing a response from soil.

15. The method according to claim 1, wherein the transmit magnetic field is a multiple-frequency magnetic field; and wherein the vector subspace comprises a number of dimensions equal to two times a number of frequencies of the multiple-frequency magnetic field.

16. The method of claim 1, wherein the indicator output is at least two numeric target identification numbers further indicative of identities of at least two targets, and which are displayed in two different regions of a user interface.

17. The method of claim 1, where the indicator output is an audio output further indicative of identities of at least two targets.

18. The method according to claim 14, wherein the step of producing an indicator output depends on the closeness from each of the target models representing the response from the soil individually to the vector subspace.

19. A metal detector configured to perform the method of claim 1.

20. A non-transitory computer readable medium, comprises instructions to perform the method of claim 1.
